(19) United States
(12) Patent Application Publication
(10) Pub. No.: US 2007/0091427 A1
(43) Pub. Date: Apr. 26, 2007

(54) POLARIZED PHASE MICROSCOPY

(75) Inventor: Paul C. Goodwin, Shoreline, WA (US)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: Applied Precision, LLC, Issaquah, WA (US)

(21) Appl. No.: 11/552,953

(22) Filed: Oct. 25, 2006

Related U.S. Application Data
(60) Provisional application No. 60/730,482, filed on Oct. 25, 2005.

(51) Int. Cl. G02B 21/06

(52) U.S. Cl. 359/386; 359/371

(57) ABSTRACT

A system and method of generating and acquiring phase contrast microscope images while minimizing interference with the intensity and optical quality of other microscopy modalities employing polarization and attenuation strategies for phase microscopy applications. A plane polarizing objective phase ring may be used in conjunction with a phase microscopy apparatus. Attenuated light may be controlled such that transparency may be selectively provided with respect to light in a predetermined plane. Illumination outside of the predetermined plane may be selected for phase microscopy applications. Accordingly, a polarizing objective phase ring effective for enabling polarized phase microscopy may reduce interfere with normal usage of the microscope for other applications such as, for example, fluorescence microscopy.

### CROSS REFERENCE TO RELATED APPLICATIONS

The present application claims benefit from the priority of U.S. Provisional Patent Application No. 60/730,482, filed Oct. 25, 2005, entitled “Polarized Phase Microscopy,” which application is incorporated herein by reference and for all purposes. The present application is related to U.S. nonprovisional application Ser. No. 10/742,507, filed Dec. 19, 2003 and now abandoned, which application is incorporated herein by reference and for all purposes.

### FIELD OF THE INVENTION

Aspects of the present invention relate generally to phase microscopy imaging systems, and more particularly to a system and method employing polarized illumination and attenuation strategies for phase microscopy applications.

### DESCRIPTION OF THE RELATED ART

When performing fluorescence microscopy on living cells, tissues, and organisms, it is often desirable to obtain structural information from the sample. For example, when studying the localization of protein constructs within a living cell using fluorescent proteins such as Green Fluorescent Protein (GFP), it is often desirable to describe these localizations within the context of the boundary of the cell. The cells themselves are most often devoid of inherent absorptions of light, so visualization with white light is not sufficient in many instances. Accordingly, microscopists often use methods that generate contrast by exploiting refractive index gradients between the cell and its environment and between individual organelle boundaries. The most common methods in the art for generating such contrast are differential interference contrast (DIC) microscopy and phase contrast (phase) microscopy. These methods attempt to strike a balance between two often incompatible goals: detecting fluorescence emissions with a signal to noise ratio sufficient to enable careful and thorough study, on the one hand; and minimizing or otherwise controlling potentially damaging effects of the light illuminating the cell, on the other hand.

Of the two methods mentioned above for generating contrast, DIC microscopy is most often selected for fluorescence applications because DIC techniques can be configured in such a way that the intensity of the fluorescent signal is neither significantly reduced nor degraded, maximizing the signal to noise ratio in many situations. Recent studies have demonstrated, however, that DIC microscopy introduces spatial artifacts into fluorescence microscopy systems by altering the Point Spread Function (PSF) of the optical train. This artifact is particularly disadvantageous because it is an asymmetrical blurring of the PSF, rendering correction of the optical effect through mathematical techniques such as digital deconvolution very difficult.

In phase microscopy, opaque annuli, or “phase rings,” are inserted at specific locations in the optical path. Phase rings having appropriate attenuation characteristics enable generation of contrast at interfaces between materials of different refractive indices by exploiting the phase differences between the light that passes through one material versus another. The introduction of phase rings, however, also interferes with the total intensity of the light collected by the microscope because some of the light that would normally pass through the objective lens is attenuated by one or more of the rings. Consequently, phase microscopy is most often not utilized with fluorescence microscopy applications.

Conventional technology is deficient at least to the extent that the best contrast generating method for use in conjunction with fluorescence microscopy applications tends to distort the very fluorescence whose localization is under investigation. What is needed is a phase contrast technique optimized for fluorescence microscopy.

### BRIEF DESCRIPTION OF THE DRAWINGS

FIG. 1 is a simplified block diagram illustrating components of a conventional phase microscopy system.

FIG. 2 is a simplified block diagram illustrating the phase ring configuration of a conventional phase microscopy system.

FIG. 3 is a simplified block diagram illustrating components of a polarized phase microscopy system.

FIG. 4 is a simplified block diagram illustrating the phase ring configuration of a polarized phase microscopy system.

FIGS. 5A and 5B are simplified diagrams illustrating opacity of an objective phase ring in a conventional phase microscopy system and opacity of a polarizing objective phase ring in one embodiment of a polarized phase microscopy system, respectively.

### DETAILED DESCRIPTION

Aspects of the present invention relate to generating and acquiring phase contrast microscope images while minimizing interference with the intensity and optical quality of other microscopy modalities, and without requiring the removal of any optical components. As set forth in more detail below, instead of using an entirely opaque annulus, or phase ring, in the back focal plane of the objective lens, a polarizing annulus, or polarizing phase ring, may be used. In accordance with the structural arrangements set forth herein, attenuated light may be selectively controlled, i.e. transparency may be selectively provided to emission light occurring in a predetermined plane. Accordingly, a polarizing objective phase ring effective for enabling phase microscopy may decrease interference with normal usage of the microscope for other applications such as, for example, fluorescence microscopy.

In accordance with one embodiment, for example, a method as disclosed herein may comprise: providing illumination from a source to a microscopy apparatus having a condenser lens and a polarizing objective phase ring; selectively plane-polarizing the illumination incident on the condenser lens at a predetermined plane; and selectively plane-polarizing emission light incident on the polarizing objective phase ring orthogonal to the predetermined plane.

The selectively plane-polarizing may comprise interposing a plane-polarizing condenser phase ring between the illumination source and the condenser lens. Additionally or alternatively, the selectively plane-polarizing comprises interposing an optical polarizing filter between the illumination source and the condenser lens.

A system configured and operative in accordance with the present disclosure may comprise: a microscopy apparatus comprising a condenser lens and polarizing objective phase ring; a illumination source operative to deliver light from the illumination source to the condenser lens; and the polarizing objective phase ring operative to plane-polarize light at a predetermined plane.

In some embodiments, light incident on the condenser lens is plane-polarized orthogonal to the predetermined plane. Such light may be plane-polarized by interposing a polarized optical filter between the illumination source and the microscope apparatus. Additionally or alternatively, the light is plane-polarized by interposing a polarized condenser phase ring between said source and said microscope apparatus.

The foregoing and other aspects of various embodiments of the present invention will be apparent through examination of the following detailed description thereof in conjunction with the accompanying drawings.

Turning now to the drawing figures, FIG. 1 is a simplified block diagram illustrating components of a conventional phase microscopy system known in the art. As illustrated in FIG. 1, a phase microscopy system 100 generally comprises an illumination source 190 configured and operative to provide illumination or excitation light. Such light passes through an illumination or condenser phase ring 110 and condenser optics 120 to illuminate specimen material (sample 199) maintained, for example, on a microscope slide, a biological chip (bio-chip), or other apparatus supported, attached, or otherwise disposed at a support 130. In that regard, support 130 may generally be embodied in or comprise a movable microscope stage, for example. Light emitted from, or transmitted through, sample 199 is collected by an objective lens 140 and passed to an objective phase ring 150. As various components of system 100 are generally known in the art, an exhaustive description of the functionality and interoperability these components for phase microscopy applications is not provided here. The following description is not intended to be construed as limiting the contexts and environments in which embodiments of the invention have utility.

Illumination source 190 is typically a broad-spectrum light source, generating light across the entire visible range (or substantially all of the visible range) of the electromagnetic spectrum, i.e., a wavelength range from approximately 300 nm to approximately 700 nm. Condenser phase ring 110 and objective phase ring 150 are substantially opaque for all visible wavelengths. Those of skill in the art will appreciate that “substantially opaque,” in this context, generally refers to the ability of condenser phase ring 110 and objective phase ring 150 to attenuate all, or a desired percentage of, light in the visible range or some specified range of wavelengths. In that regard, condenser phase ring 110 and objective phase ring 150 selectively limit transmission of electromagnetic energy at particular wavelengths; in the case of system 100 employing objective phase ring 150, this range of wavelengths is usually approximately 300 nm-700 nm as set forth above.

During operation of system 100, excitation light from source 190 illuminates the specimen or sample 199 disposed on support 130. Condenser phase ring 110 and objective phase ring 150 are aligned such that light passing through objective lens 140 (emission light) that is substantially unchanged in phase is largely attenuated by objective phase ring 150, while light that is substantially changed in phase is accentuated. Since condenser phase ring 110 and objective phase ring 150 are opaque across a broad spectrum of wavelengths, the phase image of light passing through objective phase ring 150 is polychromatic. Further, since objective phase ring 150 is opaque across the visible spectrum, any visible light that is transmitted through objective lens 140 will be attenuated, thereby limiting the intensity of emission light for all applications of system 100.

Specifically, if system 100 is intended for use in other modalities of microscopy in addition to phase microscopy applications (e.g., such as fluorescence microscopy), objective phase ring 150 may also attenuate signals from those selected modalities.

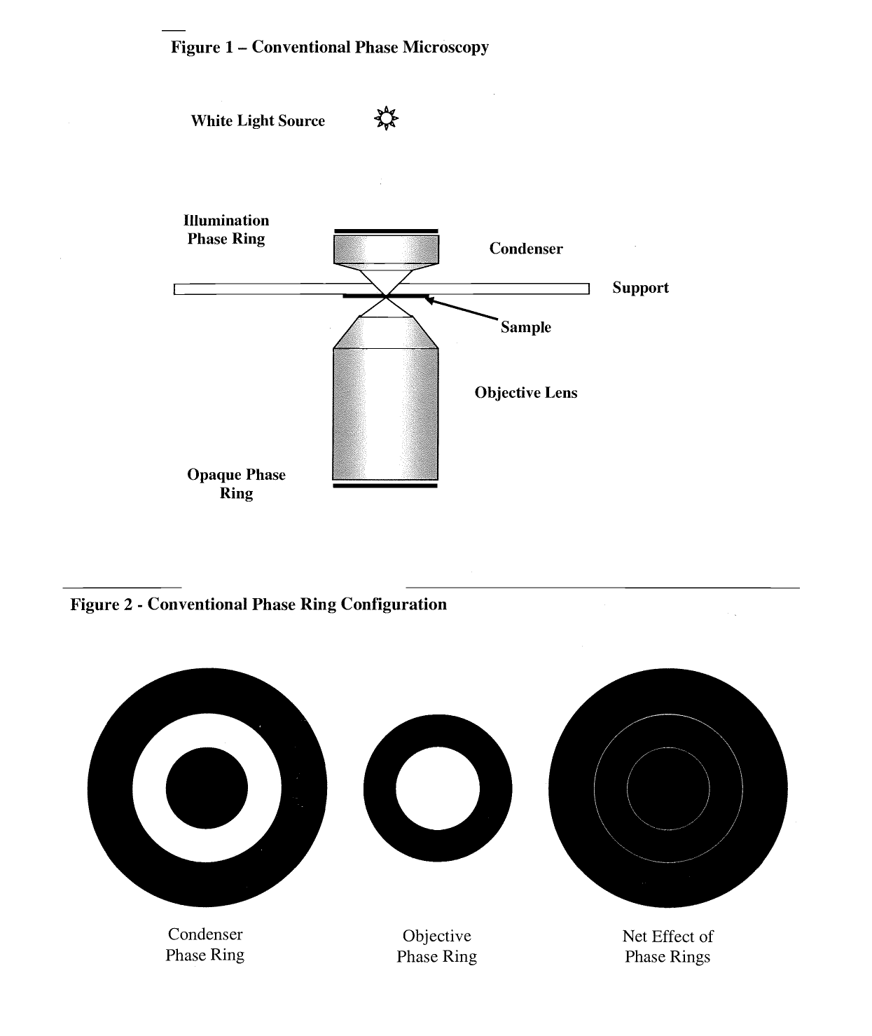

In that regard, FIG. 2 is a simplified diagram illustrating the opacity of condenser phase ring 110, objective phase ring 150 and the net effect or opacity of the combination of condenser phase ring 110 and objective phase ring 150. As indicated in FIG. 2, the opacity of objective phase ring 150 is the reciprocal to the opacity of condenser phase ring 110. Alternatively stated, the opacity of objective phase ring 150 is complementary to the transparency of condenser phase ring 110.

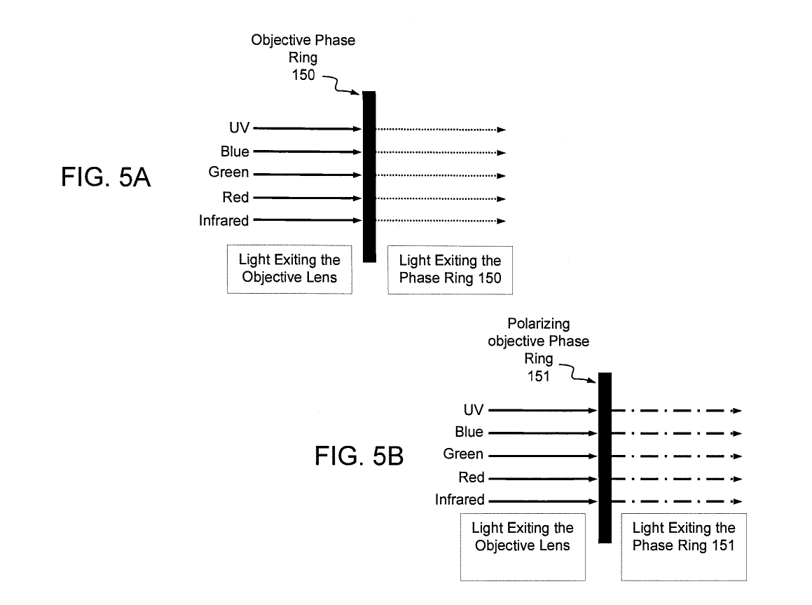

FIG. 5A is an additional example illustrating opacity of an objective phase ring in a conventional phase microscopy system. As indicated in FIG. 5A, light emitted or transmitted by sample 199 and exiting objective lens 140 (represented by the solid lines on the left side of FIG. 5A) is attenuated (as indicated by the dotted lines) by objective phase ring 150 regardless of wavelength. The functional utility and flexibility of system 100 employing objective phase ring 150 is generally limited accordingly.

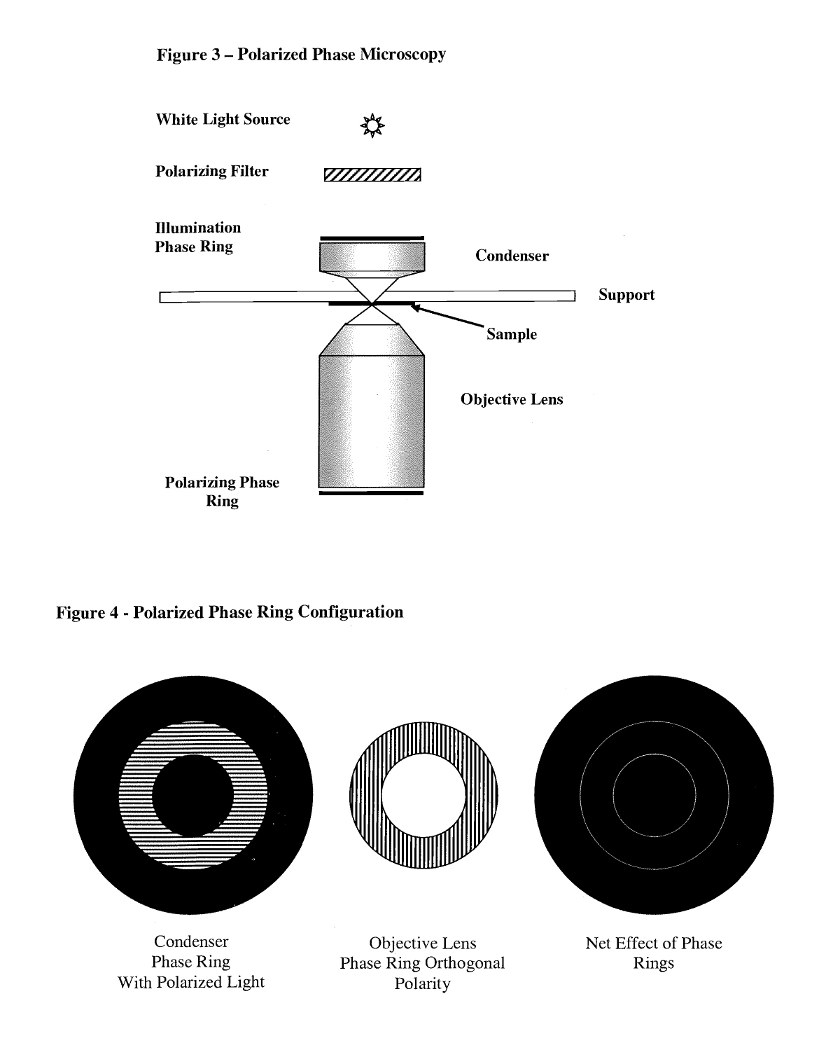

FIG. 3 is a simplified block diagram illustrating components of one embodiment of a polarized phase microscopy system configured and operative in accordance with the present disclosure. As illustrated in FIG. 3, a polarized phase microscopy system 101 may generally comprise an illumination source 190 configured and operative to provide illumination or excitation light. Such light passes through optical polarizing filter 200, condenser phase ring 110 and condenser 120 to illuminate sample 199 disposed at support 130. Emission light from sample 199 is collected by objective lens 140 and passed to polarizing objective phase ring 151.

During operation of system 101, light from source 190 is plane-polarized at a predetermined plane by optical polarizing filter 200. Such plane-polarized light passes through condenser phase ring 110 and condenser 120 to illuminate sample 199. Condenser phase ring 110 and polarizing objective phase ring 151 are aligned such that plane-polarized light passing through objective lens 140 (plane-polarized emission light) that is substantially unchanged in phase by sample 199 is largely attenuated by polarizing objective phase ring 151, which is oriented operatively to plane-polarize light perpendicular, or orthogonal, to optical polarizing filter 200. In effect, crossing optical polarizing filter 200 and polarizing objective phase ring 151 results in extinction of the plane-polarized emission light substantially unchanged in phase. In contrast, light passing through objective lens 140 (plane-polarized emission light) that is substantially changed in phase by sample 199 is largely accentuated by polarizing objective phase ring 151. Since polarizing objective phase ring 151 is transparent to light incident at the same wave-plane as polarizing objective phase ring 151, emission light for all applications, other than phase contrast microscopy, will be attenuated to a lesser degree than a conventional phase microscopy system.

By way of example, polarizing optical filter 200 may be interposed in the light path between broad-spectrum light source 190 and condenser phase ring 110. Any of various polarizing optical filters known in the art or developed and operative in accordance with known principles may provide plane-polarized light at a predetermined plane to condenser phase ring 110. Certain combination or alternative embodiments of the present invention may additionally utilize a wavelength-specific polarizing optical filter operable to plane-polarize specific wavelengths of light. Such wavelength-specific plane-polarizing optical filters may, for example, include or incorporate an interference coating of appropriate material and orientation to achieve any desired wavelength-specific opacity.

In that regard, FIG. 4 is a simplified diagram illustrating the opacity of optical polarizing filter 200, condenser phase ring 110, polarizing objective phase ring 151 and the net effect or opacity of the combination of condenser phase ring 110 emitting plane-polarized light and polarizing objective phase ring 151. As indicated in FIG. 4, the opacity of polarizing objective phase ring 151 is the complementary to the opacity of condenser phase ring 110 with plane-polarized light.

In that regard, FIG. 5B is a simplified diagram illustrating opacity of a polarizing objective phase ring in a polarized phase microscopy system. As indicated in FIG. 5B, light emitted or transmitted by sample 199 and exiting objective lens 140 (represented by the solid lines on the left side of FIG. 5B) is substantially without attenuation (as indicated by the interrupted solid lines). The functional utility and flexibility of system 101 employing polarizing objective phase ring 151 is generally enhanced accordingly, as compared to a conventional phase microscopy system.

In another embodiment of polarized phase microscopy system 101, the optical polarization filter is omitted and illumination light is instead plane-polarized by utilizing a polarizing condenser phase ring. Such a polarizing condenser phase ring is operable to deliver plane-polarized light to condenser lens 120, substantially identical to that previously described through utilization of the optical polarizing filter 200. The difference being that the illumination light is plane-polarized by the polarizing condenser phase ring instead of optical polarization filter 200. Any of various polarizing optical techniques known in the art or developed and operative in accordance with known principles may enable a condenser phase ring to provide plane-polarized light at a predetermined plane to condenser lens 120.

Certain combination or alternative embodiments of the present invention may additionally utilize a wavelength-specific polarizing condenser phase ring operable to plane-polarize specific wavelengths of light. Such wavelength-specific polarizing condenser phase ring may, for example, include or incorporate an interference coating of appropriate material and orientation to achieve any desired wavelength-specific opacity.

Polarizing objective phase ring 151 may be situated or disposed at the back aperture of objective lens 140. In one exemplary embodiment, polarizing objective phase ring 151 may be substantially transparent to all visible light incident upon polarizing objective phase ring 151 at the same wave-plane as that of polarizing objective phase ring 151. Conversely, in the wave-planes other than the wave-plane of polarizing objective phase ring 151, objective phase ring 151 may be substantially opaque.

In accordance with some embodiments of a polarized phase microscopy system, polarizing objective phase ring 151 may be fabricated of various polarizing optical filters known in the art or developed and operative in accordance with known principles that provide plane-polarized light at a predetermined plane. Additionally or alternatively, objective phase ring 151 may be fabricated to include or incorporate an interference coating of appropriate material and orientation to achieve any desired plane-polarization. Various methods of constructing phase rings and applying coatings thereto are generally known in the art of optics and optical component design. The present disclosure is not intended to be limited to any particular material, coating technique, or design parameters with respect to manufacture and preparation of polarizing objective phase ring 151 or polarizing condenser phase ring 110.

Certain combination of embodiments of the present invention may additionally, or alternatively, utilize a wavelength-specific polarizing objective phase ring operable to plane-polarize selected wavelengths of light. Such wavelength-specific polarizing objective phase ring may, for example, include or incorporate an interference coating of appropriate material and orientation to achieve any desired wavelength-specific opacity.

It will be appreciated that light from other modalities (e.g., such as fluorescence) passing through objective lens 140 may remain substantially unaffected by operation of polarizing objective phase ring 151.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

1. A method comprising:
providing illumination to a condenser lens;
selectively plane-polarizing said illumination incident on said condenser lens in a first plane;
transmitting said plane-polarized illumination to sample;
selectively plane-polarizing emission light received at an objective lens from said sample in a second plane substantially orthogonal to said first plane.

2. The method of claim 1 wherein said selectively plane-polarizing said illumination light comprises interposing a plane-polarizing condenser phase ring between said illumination and said condenser lens.

3. The method of claim 1 wherein said plane-polarizing objective phase ring is substantially opaque to selected wavelengths of light.

4. The method of claim 1 wherein said selectively plane-polarizing said emission light includes polarizing a portion of said emission light at a plane-polarizing objective phase ring.

5. The method of claim 1 wherein said selectively plane-polarizing comprises interposing an optical polarizing filter between said illumination and said condenser lens.

6. A microscopy system comprising:
a condenser lens;
a polarizing objective phase ring, operative to plane-polarize light at a predetermined plane; and
an illumination source operative to deliver light from said source to said condenser lens.

7. The system of claim 6 wherein said light incident on said condenser lens is plane-polarized orthogonal to said predetermined plane.

8. The system of claim 7 wherein said light is plane-polarized by interposing a polarized optical filter between said source and said microscope apparatus.

9. The system of claim 7 wherein said light is plane-polarized by interposing a polarized condenser phase ring between said source and said microscope apparatus.
